(19) United States
(12) Patent Application Publication
(10) Pub. No.: US 2007/0176946 A1
(43) Pub. Date: Aug. 2, 2007

(54) IMAGE FORMING APPARATUS, CONTROL METHOD THEREOF, AND PROGRAM FOR IMPLEMENTING THE METHOD

(75) Inventor: Tatsuo MATOBA, Yokohama-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/625,860

(22) Filed: Jan. 23, 2007

(30) Foreign Application Priority Data
Jan. 31, 2006 (JP) 2006-022773

(51) Int. Cl. G09G 5/00

(52) U.S. Cl. 345/619

(57) ABSTRACT

An image forming apparatus which enables even a user inexperienced in configuration operations to easily configure settings of a job. A touch panel section displays a configuration screen for use in carrying out configuration operations concerning a job. A storage section stores history records, on an executed job-by-executed job basis, each of the history records containing configuration information indicating a configuration concerning each job. A job history selection section selects one of the history records stored in the storage section. A CPU causes the touch panel section to sequentially display a series of configuration screens for use in carrying out configuration operations indicated by configuration information contained in the one of the history records selected by the job history selection section.

### BACKGROUND OF THE INVENTION

1. Field of the Invention

The present invention relates to an image forming apparatus which is capable of reproducing configuration information of a job using the associated job history record, a method of controlling the image forming apparatus, and a program for implementing the method.

2. Description of the Related Art

Recently, an operational procedure for operating an image forming apparatus has been becoming more and more complicated as the functions of the image forming apparatus become more sophisticated. For example, to use a certain function of the image forming apparatus, it is required to perform complicated configuration operations on a plurality of configuration screens by sequentially switching from one screen to another, on an operating panel of the apparatus. It is not easy for ordinary users having no expertise to carry out the complicated operations. Further, for effective utilization of applied functions, the ordinary users are required to master how to carry out more complicated operations, which makes it difficult for the ordinary users to make advanced use of the applied functions of the apparatus.

As one of methods for solving the above problem, there has been proposed a method of storing parameters set for image formation as history information in a memory or the like (see e.g. Japanese Laid-Open Patent Publication (Kokai) No. 2005-033380). In this method, parameters set by reading out the stored history information are displayed on the display section of an operation panel, and the displayed parameters are used for the following image forming operations.

There has also been proposed another method of displaying set parameters using a micro key memory in which a plurality of key operations are registered in advance (see e.g. Japanese Laid-Open Patent Publication (Kokai) No. 2002-142056). In this method, when the user confirms parameters stored in the micro key memory, light emitting elements corresponding to keys for which parameters are stored are sequentially lighted, thereby enabling the stored parameters to be set to the keys.

However, in the former method, only configured settings are displayed when the history information is used for using the configured parameters again. Therefore, user cannot confirm transitions between screens and an operational procedure for properly performing button press operations, on the operation panel, and hence it is difficult to fully learn the operational procedure if the user is inexperienced in operating the apparatus.

In the latter method, to utilize the macro key memory, a user has to register an operational procedure supposed to be repeatedly used, in the macro key in advance, which is troublesome for the user.

### SUMMARY OF THE INVENTION

It is an object of the present invention to provide an image forming apparatus which enables even a user inexperienced in configuration operations to easily configure settings of a job, a method of controlling the image forming apparatus, and a program for implementing the program.

To attain the above object, in a first aspect of the present invention, there is provided an image forming apparatus comprising a display unit adapted to display a configuration screen for use in carrying out configuration operations concerning a job, a storage unit adapted to store history records, on an executed job-by-executed job basis, each of the history records containing configuration information indicating a configuration concerning each job, a selection unit adapted to select one of the history records stored in the storage unit, and a display control unit adapted to cause the display unit to sequentially display a series of configuration screens for use in carrying out configuration operations indicated by configuration information contained in the one of the history records selected by the selection unit.

Preferably, the image forming apparatus further comprises a screen information storage unit adapted to store configuration screen information items associated with respective configuration information items, and a generation unit adapted to identify configuration screen information corresponding to the configuration information contained in the history record selected by the selection unit, from the configuration screen information items stored by the screen information storage unit, and determine a sequence of display of the series of configuration screens, based on display order information contained in the identified configuration screen information, to thereby generate display information, and the display control unit causes the display unit to sequentially display the series of configuration screens based on the display information generated by the generation unit.

Preferably, the image forming apparatus further comprises a configuration changing unit adapted to modify the configuration information by accepting a modification made to the configuration information on any of the configuration screens displayed on the display unit by the display control unit.

Preferably, the selection unit extracts a list of history records of normally completed jobs as candidates for selection.

Preferably, the image forming apparatus further comprises a job type selection unit adapted to select a type of a job to be executed, and wherein the selection unit extracts history records of jobs of the same type as the job type selected by the job type selection unit, as the candidates for selection.

To attain the above object, in a second aspect of the present invention, there is provided a method of controlling an image forming apparatus including a display unit adapted to display a configuration screen for use in carrying out configuration operations concerning a job, and a storage unit adapted to store history records, on an executed job-by-executed job basis, each of the history records containing configuration information indicating a configuration concerning each job, comprising a job history selection step of selecting one of the history records stored in the storage unit, and a display control step of causing the display unit to sequentially display a series of configuration screens for use in carrying out configuration operations indicated by configuration information contained in the one of the history records selected in the job history selection step.

To attain the above object, in a third aspect of the present invention, there is provided a program executable by an image forming apparatus including a display unit adapted to display a configuration screen for use in carrying out configuration operations concerning a job, and a storage unit adapted to store history records, on an executed job-by-executed job basis, each of the history records containing configuration information indicating a configuration concerning each job, comprising a job history selection module for selecting one of the history records stored in the storage unit, and a display control module for causing the display unit to sequentially display a series of configuration screens for use in carrying out configuration operations indicated by configuration information contained in the one of the history records selected by the job history selection module.

The above and other objects, features, and advantages of the invention will become more apparent from the following detailed description taken in conjunction with the accompanying drawings.

### BRIEF DESCRIPTION OF THE DRAWINGS

FIG. 1 is a longitudinal cross-sectional view of an image forming apparatus according to an embodiment of the present invention;

FIG. 2 is a block diagram of a control section appearing in FIG. 1;

FIG. 3 is a schematic plan view of an operating section appearing in FIG. 2;

FIG. 4 is a view showing an example of an initial screen displayed on a touch panel section appearing in FIG. 3;

FIG. 5 is a view showing an example of a “template configuration” screen displayed when a user presses a template configuration key appearing in FIG. 4;

FIG. 6 is a view showing an example of a screen transition for reproducing a procedure for configuring a copy job;

FIG. 7 is a view showing an example of a screen transition for reproducing the procedure for configuring the copy job;

FIG. 8 is a view showing an example of a screen transition for reproducing the procedure for configuring the copy job;

FIG. 9 is a view showing an example of a screen transition for reproducing the procedure for configuring the copy job;

FIG. 10 is a view showing an example of a screen transition for reproducing the procedure for configuring the copy job;

FIG. 11 is a view showing an example of a job history table stored in a job history storage area in a storage section;

FIG. 12 is a view showing an example of screen layout information stored in a screen configuration storage area of the storage section;

FIG. 13 is a view showing an example of a screen configuration/transition macro stored in a macro information storage area of the storage section; and

FIG. 14 is a flowchart of a process for reproducing a series of configuration screens corresponding to a job history information item selected by the user, on the touch panel, in the order of transition of the screens.

### DETAILED DESCRIPTION OF THE PREFERRED EMBODIMENTS

The present invention will now be described in detail below with reference to the drawings showing a preferred embodiment thereof.

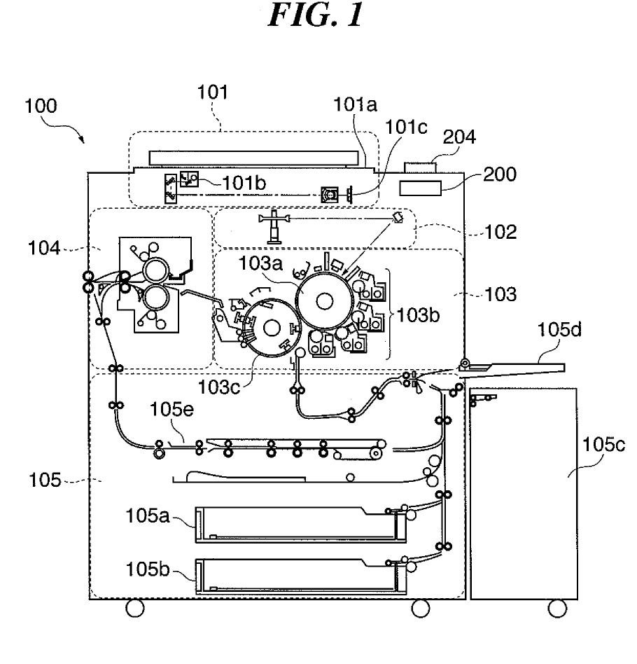

FIG. 1 is a longitudinal cross-sectional view of an image forming apparatus (hereinafter referred to as “the MFP (Multi Function Peripheral)”) according to the present embodiment. The MFP functions as a full-color image forming apparatus that is capable of forming a full-color image, and performs a plurality of functions, such as a copying function, a scanning function, a facsimile function, and a printing function.

As shown in FIG. 1, the MFP 100 is comprised of a scanner section 101, a laser exposure section 102, an image forming section 103, a fixing section 104, a sheet feeding/conveying section 105, an operating section 204, and a control section 200. The laser exposure section 102, the image forming section 103, the fixing section 104, and the sheet feeding/conveying section 105 cooperate to form a printer section.

The scanner section 101 has a scanner unit 101b that moves in the sub-scanning direction while illuminating an original placed on an original platen glass 101a, to thereby guide reflected light from the original onto a CCD 101c. The CCD 101c converts the reflected light guided by the scanner unit 101b into an electric signal. The electric signal is input to the control section 200. The control section 200 converts the input electric signal into a digital signal, and then performs various kinds of processing on the digital signal. The processed digital signal is output as image data to the laser exposure section 102 or to an external apparatus or device via an external interface, not shown, or is stored as image data in a memory, not shown.

The laser exposure section 102 modulates a laser beam based on the image data and then outputs the modulated laser beam. The laser beam is irradiated onto a photosensitive drum 103a of the image forming section 103 while being scanned leftward and rightward by a rotary polygon mirror rotating at a constant angular velocity.

The image forming section 103 is comprised of the photosensitive drum 103a, a plurality of developing devices 103b, and a transfer drum 103c. When the photosensitive drum 103a is driven for rotation, the surface thereof is uniformly charged to a predetermined potential by a primary electrostatic charger. Then, the photosensitive drum 103a having the surface thereof charged to the predetermined potential is irradiated with the laser beam emitted from the laser exposure section 102, whereby an electrostatic latent image for a color corresponding to the irradiated laser beam is formed on the surface of the photosensitive drum 103a. The latent image is visualized as a toner image by a toner supplied from one of the developing devices 103b corresponding to the color. The toner image is transferred onto a sheet that is wound around the transfer drum 103c. The sheet has been fed from one of cassettes 105a and 105b of the sheet feeding/conveying section 105, a paper deck 105c, or a manual sheet feeder 105d.

The above-described process from formation of a latent image on the photosensitive drum 103a to transfer of a toner image onto a sheet is repeatedly executed for each of the four colors of magenta (M), cyan (C), yellow (Y), and black (K), whereby toner images in the respective colors are transferred onto the sheet in superimposed relation.

The sheet having the color toner images transferred thereon in superimposed relation is separated from the transfer drum 103c, and then is conveyed to the fixing section 104. The fixing section 104 thermally presses the full-color toner image (i.e. the superimposed color toner images) transferred onto the sheet, to thereby fix the full-color toner image on the sheet. The sheet having the full-color toner image fixed thereon is guided to be discharged from the apparatus, or guided into a double-sided printing path 105e in the sheet feeding/conveying section 105. In the case of guiding the sheet into the double-sided printing path 105e, i.e. when the apparatus is in a double-sided printing mode, the sheet is reversed or turned over so as to change the image forming surface thereof from one side to the other side, and then is guided into the double-sided printing path 105e.

The sheet feeding/conveying section 105 feeds a sheet from one of the cassettes 105a and 105b, the paper deck 105c, or the manual sheet feeder 105d, and conveys the sheet to the transfer drum 103c. The sheet is wound around the transfer drum 103c. Further, the sheet feeding/conveying section 105 conveys the sheet guided into the double-sided printing path 105e to the transfer drum 103c again.

The operating section 204 is provided with hard keys used for input for configuring functions and a display panel for displaying configured settings. Soft keys are displayed on the display panel.

The control section 200 controls each of the scanner section 101, the laser exposure section 102, the image forming section 103, the fixing section 104, and the sheet feeding/conveying section 105, based on an input from the operating section 204 such that a function associated with the input is executed.

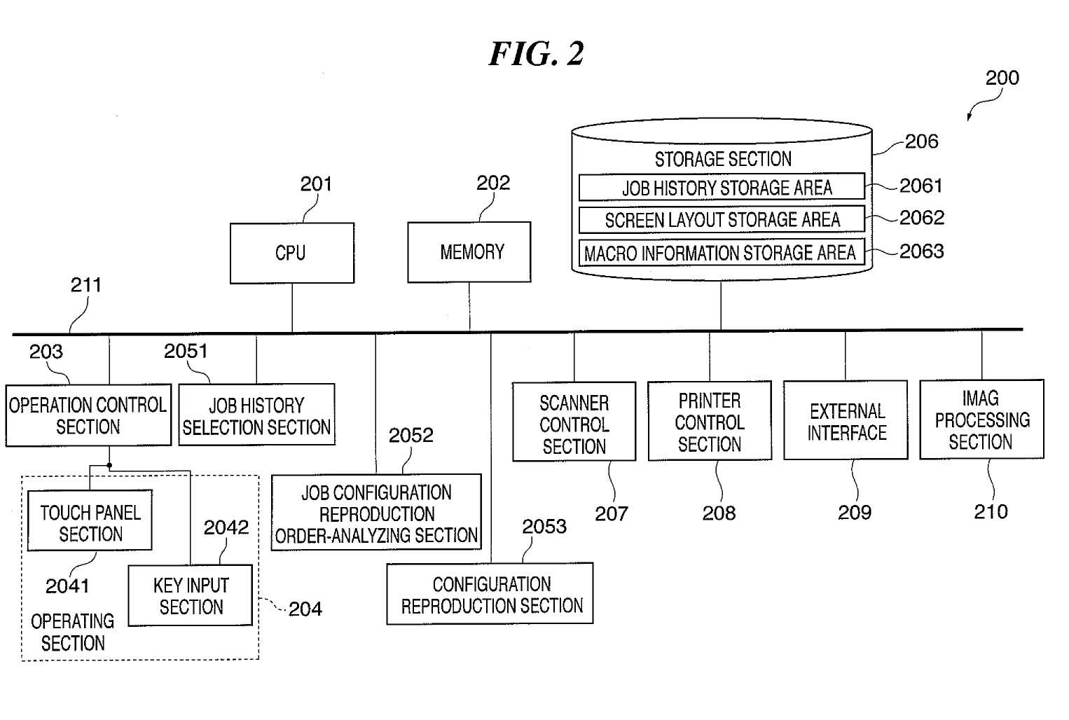

Next, the arrangement of the control section 200 will be described with reference to FIG. 2. FIG. 2 is a block diagram of the control section 200 appearing in FIG. 1.

As shown in FIG. 2, the control section 200 has a CPU 201. The CPU 201 performs various kinds of control or processing by reading out and executing associated programs stored in a memory 202 or a storage section 206. The memory 202 is comprised of a ROM that stores the various programs to be executed by the CPU 201 and a RAM that temporarily stores data necessary e.g. for control. The programs include ones for implementing a job history selection section 2051, a job configuration reproduction order-analyzing section 2052, and a configuration reproduction section 2053, respectively.

The storage section 206 is implemented by a nonvolatile memory, such as a hard disk, and stores image data generated by various processes, as well as control information, configuration information, and so forth for use in the processes. The storage section 206 is comprised of a job history storage area 2061, a screen layout storage area 2062, and a macro information storage area 2063. The job history storage area 2061 stores job history information items (history records) on an executed job-by-executed job basis. The screen layout storage area 2062 stores screen layout information items. The macro information storage area 2063 stores registered macro information items. The job history information, the screen layout information, and the macro information will be described in detail hereinafter.

Alternatively, the various programs may be stored not in the memory 202, but in the storage section 206. In the case where data is read/written from/into the storage section 206, reading/writing of the data is performed via the memory 202. The memory 202 and the storage section 206 are connected to the CPU 201 via a bus 211.

An operation control section 203, a scanner control section 207, a printer control section 208, an external interface 209, and an image processing section 210 are connected to the CPU 201 via the bus 211.

The operation control section 203 provides an interface between the CPU 201 and a touch panel section 2041 and a key input section 2042 of the operating section 204. The operation control section 203 transfers information input via the touch panel section 2041 and the key input section 2042 to the CPU 201, and delivers information to be displayed to the touch panel section 2041.

The scanner control section 207 controls the scanner section 101 based on an instruction from the CPU 201. The printer control section 208 acquires image data from the memory 202 based on an instruction from the CPU 201 and controls the laser exposure section 102, the image forming section 103, the fixing section 104, and the sheet feeding/conveying section 105, whereby an image is formed on a sheet based on the image data. The external interface 209 exchanges information with external apparatuses or devices via a network or a public communication line. Information received from the external apparatuses or devices via the external interface 209 can be printed on sheets using the printing function. Further, image data or facsimile data read by the scanner section 101 is transmitted by the external interface 209 via the network or the public communication line. The image processing section 210 performs, on image data, image processing corresponding to an input operation carried out by the user via the operating section 204, image processing for improving image quality and so forth. Further, for facsimile transmission, the image processing section 210 performs processing for converting a resolution, a sheet size, and so forth associated with image data to be sent, in accordance with the capabilities of a transmission destination.

The CPU 201 executes the programs stored in the memory 202 for software implementation of the job history selection section 2051, the job configuration reproduction order-analyzing section 2052, and the configuration reproduction section 2053. Although these sections actually implemented in software need not be explicitly represented in FIG. 2 as in the case of hardware configuration, explicit representation thereof is made here so as to clarify the operations of these sections.

The job history selection section 2051 extracts a list of job history information items as candidates for selection of a configuration to be reproduced from the job history storage area 2061 of the storage section 206, and selects one job history information item from the list in response to a selection operation carried out by the user. The job configuration reproduction order-analyzing section 2052 analyzes the sequence of steps of the job configuration based on the job history information item selected by the job history selection section 2051 and a screen layout information item stored in the screen layout storage area 2062 in association with the job history information item. Then, the job configuration reproduction order-analyzing section 2052 generates a screen configuration/transition macro which defines, for provisional use, a series of configuration screens for reproducing job configuration information and the sequence of transitions of the screens, based on the result of the analysis. Further, based on the screen configuration/transition macro generated by the job configuration reproduction order-analyzing section 2052, the configuration reproduction section 2053 reproduces the series of configuration screens in the transition order, and displays the configuration screens on the touch panel section 2041.

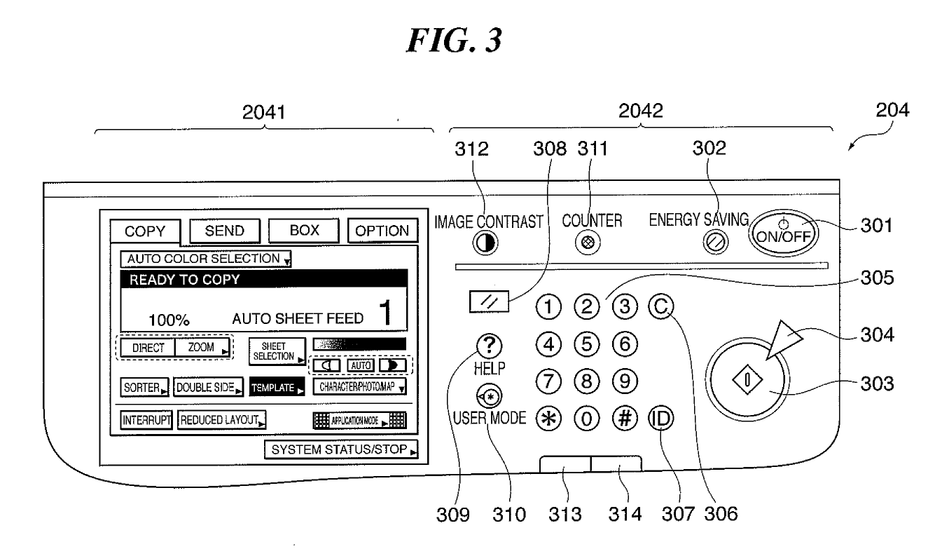

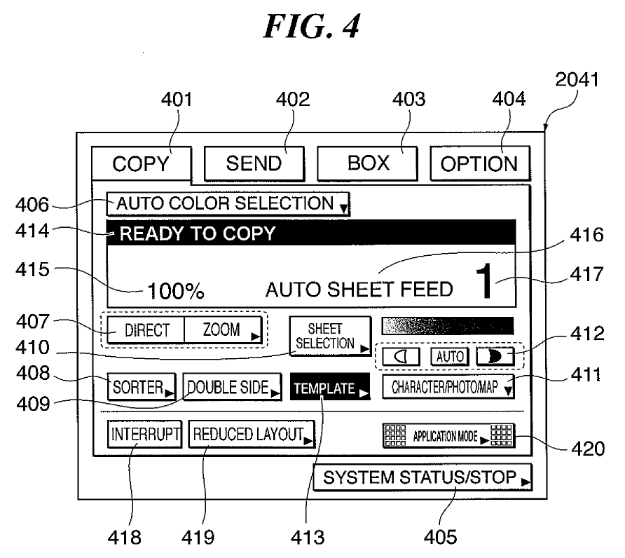

Next, the arrangement of the operating section 204 will be described with reference to FIGS. 3 and 4. FIG. 3 is a schematic plan view of the operating section 204 appearing in FIG. 2. FIG. 4 is a view showing an example of an initial screen displayed on the touch panel section 2041 appearing in FIG. 3.

As shown in FIG. 3, the operating section 204 is comprised of the touch panel section 2041 and the key input section 2042. The touch panel section 2041 is comprised of a liquid crystal display panel and a touch panel affixed to the liquid crystal display panel. On the touch panel section 2041, there are displayed various soft keys and information indicative of the current settings, the current operating state, and so forth, as described hereinafter.

The key input section 2042 is comprised of various hard keys 301 to 312 used to configure normal operations, an execution/memory lamp 313, and an error lamp 314. The operating section power supply switch 301 as one of the hard keys is used for switching a mode to be applied when a main power supply switch, not shown, for supplying electric power to the entire apparatus is in its ON state between a standby mode (normal operating state) and a sleep mode. The sleep mode is a state awaiting an interrupt, such as an operational instruction input by the user to the operating section 204, a reception of a print job from the external apparatus or device, or a reception of a facsimile transmission. In the sleep mode, the programs are held in stoppage so as to reduce power consumption.

An energy-saving key 302 is used to set the control temperature of the fixing section 104 such that the control temperature is held low, so as to reduce power consumption. A start key 303 is used to give an instruction for starting a copying operation, a facsimile transmission operation, or the like, and the stop key 304 is used to stop an operation started in response to the instruction given via the start key 303. Ten keys 305 are used to enter numerals for various configurations, and a clear key 306 is used to cancel the numerals. An ID key 307 is used by the user of the MFP 100 to enter a predetermined password for user authentication. A reset key 308 is used to nullify a configuration and return the configuration to its default state. A help key 309 is used to display a guidance screen or a help screen. A user mode key 310 is used to shift to a user-specific system configuration screen.

A counter confirmation key 311 is used to display a delivered sheet count stored in a software counter provided in the MEP 100, for counting printed sheets. By pressing the counter confirmation key 311, it is possible to display a delivered sheet count according to each operation mode (copying, printing, scanning, or facsimile), or according to each color mode (color or monochrome), or according to a sheet size (large or small). The image contrast dial 312 is used to adjust screen visibility e.g. by controlling a backlight of the liquid crystal display panel of the touch panel section 2041.

The execution/memory lamp 313 flashes on and off during job execution or memory access to thereby notify the user that a job is being executed or that the memory is being accessed. The error lamp 314 flashes on and off e.g. when a serviceman call error occurs or when an operator call occurs to announce occurrence of paper jamming, running-out of consumables, or the like, to thereby notify the user that the job execution is impossible.

When a copy tab 401 is selected, a screen shown in FIG. 4 is displayed on the touch panel section 2041, as an initial screen in the standby mode. On the initial screen are displayed not only various soft keys 401 to 413 and 418 to 420, but also information items 415 to 417 including information on the current apparatus status. On the touch panel section 2041, various operating screens can be displayed in response to respective configuration operations. Although in the present embodiment, the screen designated by selection of the copy tab 401 is displayed as the initial screen in the standby mode, a screen corresponding to one of other tabs 402 to 404 may be displayed as the initial screen.

By selecting one of the tab keys 401 to 404, it is possible to switch to an operation mode corresponding to the selected tab key. The copy tab 401 is used to perform transition to an operating screen for a copying operation. A send tab 402 is used to perform transition to an operating screen for giving an instruction for a data send operation, such as a facsimile send operation or an E-mail send operation. A box tab 403 is used to perform transition to a screen for inputting/outputting a job to/from a box (storage means for storing jobs on a user-by-user basis). An option tab 404 is used to perform transition to a screen for configuring various extension functions including the scanning function.

A system monitor key 405 is used to display the status and conditions of the MFP 100. A color selection/setting key 406 is used to preselect one of a color copying mode, a monochrome copying mode, and an automatic selection mode. A magnification setting key 407 is used to perform transition to a screen for setting a magnification, such as 100% magnification, enlargement, or reduction. The post-processing configuration key 408 is used to perform transition to a screen for setting whether or not to carry out stapling or punching, the number of staples or punches, and stapling positions or punching positions. A double-sided printing-setting key 409 is used to perform transition to a screen for selecting one of double-sided printing and single-sided printing. A sheet size-setting key 410 is used to perform transition to a screen for selecting a sheet cassette, a sheet size, and a media type. An image mode-setting key 411 is used to select one of a character mode, a photograph mode, and so forth, as an image mode suited to an original image. A density setting key 412 is used to carry out density adjustment to increase or reduce print density of an image printed out.

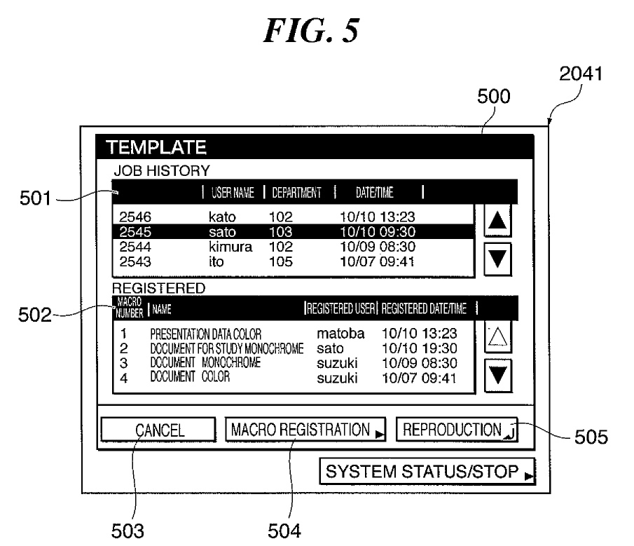

The template configuration key 413 is used to perform transition to a “template configuration” screen 500 (see FIG. 5) for enabling job history-based reproduction of an operational configuration. In the present embodiment, the template configuration key 413 is provided for each of the tabs 401 to 404.

An interrupt key 418 is operated to cause another job to interrupt a copying operation. A reduced layout configuration key 419 is used to call a series of screens for configuring a reduced layout. An application mode key 420 is used to perform transition to a screen for carrying out various kinds of image processing, such as duplex-to-duplex copy, cover/interleaved sheet setting, reduced layout, and image shift, and configuring a layout.

The information items displayed on the initial screen (screen corresponding to the copy tab 401) include status information 414, magnification information 415, sheet size information 416, and copy count information 417. On the initial screen, a message “Ready to copy” is displayed as the status information 414, “100%” as the magnification information 415, “auto sheet feed” as the sheet size information 416, and “1” as the copy count information 417. These information values are initial values, each of which is changed according to the operation state or the configuration operation. For example, the status information 414 is changed according to the operational status of the apparatus, to display e.g. “standby state”, “warm-up time”, “jam”, or “error”.

Next, the “template configuration” screen 500 displayed when the user presses the template configuration key 413 on the initial screen shown in FIG. 4 will be described with reference to FIG. 5. FIG. 5 is a view showing an example of the “template configuration” screen 500 displayed when the template configuration key 413 appearing in FIG. 4 is pressed by the user.

When the template configuration key 413 is pressed by the user on the initial screen shown in FIG. 4, the “template configuration” screen 500 shown in FIG. 5 is displayed on the touch panel 2041. On the “template configuration” screen 500 are displayed a job history/selection list 501, a registered macro/selection list 502, a cancel key 503, a macro registration key 504, and a reproduction key 505.

In the job history/selection list 501, there are displayed the acceptance number, user name, department number, and date/time of job history information items which correspond to a caller tab (from which the present screen is called) and are extracted from the job history storage area 2061 of the storage section 206. Processing for extracting the specific job history information items corresponding to a caller tab and displaying the information items as a list is executed by the job history selection section 2051. In the present example, since the caller tab is the “copy tab” 401, reusable history information items of respective copy jobs excluding error jobs and canceled ones are extracted as candidates for selection, and there are displayed the acceptance number, user name, department number, and date/time of each extracted copy job history information item.

It is possible to select a desired history information item from the history information list displayed in the job history/selection list 501, by user operation. The selection operation can be performed by touching a line of the desired history information item on the job history/selection list 501. Further, it is possible to call and display (scroll the screen view to show) other job history information items by using arrow keys on the right side. In the illustrated example, a job history item with acceptance number 2545 is selected.

In the registered macro/selection list 502, there are displayed the macro number, macro name, registered user, and registration date/time of each of screen configuration/transition macro information items which correspond to a caller tab and are extracted from the macro information storage area 2063 of the storage section 206. Processing for extracting the screen configuration/transition macro information items corresponding to the caller tab and displaying the information items as a list is executed by the job history selection section 2051. In the illustrated example, since the caller tab is the “copy tab” 401, screen configuration/transition macro information items of respective copy jobs are extracted, and there are displayed the macro number, macro name, registered user, and registration date/time of each of extracted screen configuration/transition macro information items. The screen configuration/transition macro information defines a series of screens for reproducing configuration information and a sequence of transitions of the screens.

It is possible to select a desired macro information item from the screen configuration/transition macro information list displayed in the registered macro/selection list 502, by user operation. The procedure of the selection operation is the same as that of the selection operation for selecting a job history information item. The user is allowed to select only one of job history items in the job history/selection list 501 and the screen configuration/transition macros in the registered macro/selection list 502.

The cancel key 503 is a button used for switching the “template configuration” screen 500 back to a screen corresponding to the caller tab. In the present example, the caller tab is the “copy tab” 401, and therefore when the cancel key 503 is pressed, the “template configuration” screen 500 returns to the screen shown in FIG. 4.

The macro registration key 504 is enabled (pressable) when a job history information item is selected from the job history/selection list 501. When the macro registration key 504 is pressed, a screen configuration/transition macro is generated based on the selected job history information item. Further, a “macro registration” screen, not shown, for registering the generated screen configuration/transition macro is displayed. A name and other items associated with the screen configuration/transition macro generated based on the selected job history information item are entered on the “macro registration” screen. Further, the screen configuration/transition macro is assigned a macro number and is stored in the macro information storage area 2063 of the storage section 206. The information of the screen configuration/transition macro thus registered is additionally displayed on the registered macro/selection list 502.

The reproduction key 505 is enabled when one job history is selected from the job history/selection list 501, or when one screen configuration/transition macro is selected from the registered macro/selection list 502. Then, when the reproduction key 505 is pressed by the user, a “confirmation” dialog, not shown, is displayed. In the “confirmation” dialog, a confirmation message saying e.g. “Is it OK to reproduce a configuration procedure based on the selected job history or the selected macro?”, is displayed. When an answer (e.g. “YES”) is input in response to this confirmation message, the “template configuration” screen 500 is closed.

If a job history information item for a copy job is selected here, the contents of the selected job history and the associated contents in the screen layout storage area 2062 are analyzed by the job configuration reproduction order-analyzing section 2052, whereby a series of configuration screens and a sequence of transitions of the screens are obtained. When the series configuration screens and the sequence of transitions of the screens are obtained, the configuration reproduction section 2053 reproduces the obtained series configuration screens in the transition order on the screen under the “copy tab” 401. For example, the series of configuration screens are reproduced in the transition order, in an animation-like manner, at predetermined time intervals (e.g. 0.5 sec.) which allow the user to view each screen.

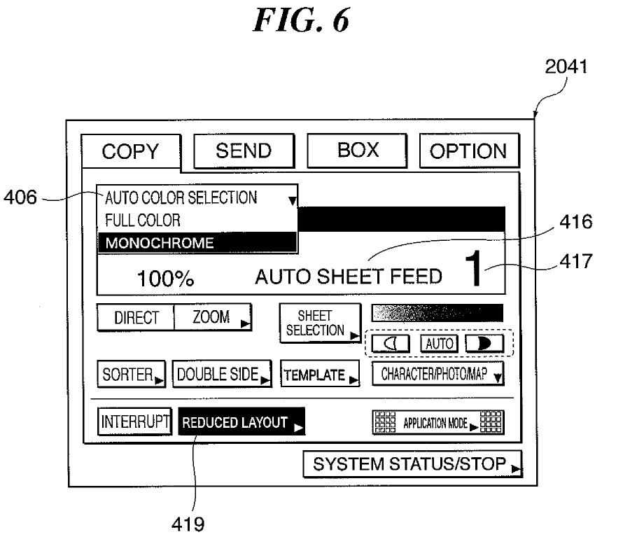

Next, an example of transitions of screens reproduced on the touch panel section 2041 when the reproduction key 505 is pressed by the user on the “template configuration” screen 500 will be described with reference to FIGS. 6 to 10. FIGS. 6 to 10 show an example of screen transitions in the case of reproduction of a series of configuration screens associated with a copy job. Here, a description will be given of the case where a series of configuration screens are reproduced for a copy job in which the color is set to “monochrome”, the page layout to “2 in 1”, the original size to “A4”, the sheet type to “A4 plain sheet”, the printing mode to “double-sided”, and the copy count to “1”.

It is now assumed that the job history in the job history/selection list 501 includes a job history item of a copy job configured as above and that the job history item is selected. In this case, when the user presses the reproduction key 505 on the “template configuration” screen 500 (see FIG. 5), the “template configuration” screen 500 is closed, and the screen under the “copy tab” 401 as the caller tab is displayed. Then, reproduction of the series configuration screens is started.

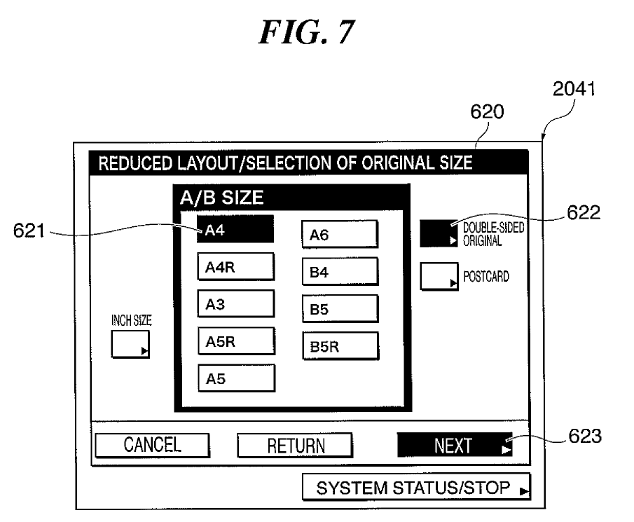

Next, as shown in FIG. 6, on the screen under the “copy tab” 401, first, there are displayed operations of setting the copy count information to “1”, and then selecting “monochrome” by pulling down the color selection/setting key 406. This shows operations for setting the copy count to “1”, and the color to “monochrome”. Then, the operation of pressing the reduced layout configuration key 419 is displayed, which causes an “original size selection” screen 620 shown in FIG. 7 to be displayed.

On the “original size selection” screen 620, first, there are carried out, i.e. displayed, the operation of pressing an “A4” key as one of original size selection keys 621, and then the operation of pressing a double-sided original spread direction-setting key 622. After displaying the operation of pressing the double-sided original spread direction-setting key 622, a “double-sided original setting” screen, not shown, is displayed, and on the “double-sided original setting” screen, the operation of selecting “horizontal page turn” is displayed. Thereafter, the operation of closing the “double-sided original setting” screen is displayed, and the operation of returning to the “original size selection” screen 620 is carried out or displayed.

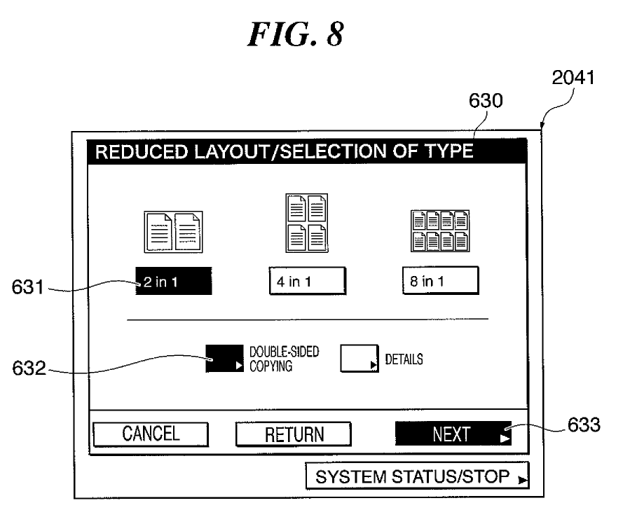

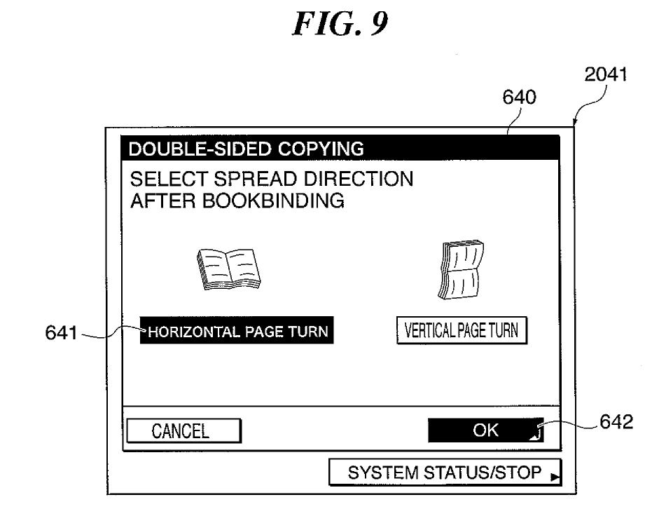

Then, on the “original size selection” screen 620, the operation of pressing a next screen key 623 is displayed, which causes a “type selection” screen 630 shown in FIG. 8 to be displayed. On the “type selection” screen 630, the operation of pressing a “2 in 1” key as one of reduced layout selection keys 631 is displayed, and then the operation of pressing a double-sided copy: finish opening direction-setting key 632 is displayed. By depression of this key 632, a “double-sided copy setting” screen 640 shown in FIG. 9 is displayed.

On the “double-sided copy setting” screen 640, the operations of pressing a “horizontal page turn” key as a finish page turn selection key 641, and then the operation of pressing an OK key 642 are displayed. As a consequence, the “double-sided copy setting” screen 640 is closed, followed by the screen returning to the “type selection” screen 630. Then, on the “type selection” screen 630, the operation of pressing a next screen key 633 is displayed, which causes a “sheet selection” screen, not shown, to be displayed. On the “sheet selection” screen, the operation of selecting a cassette containing “A4 plain sheets” is displayed, and then the operation of pressing an OK key is displayed. As a consequence, the “sheet selection” screen is closed, followed by the screen returning to the screen under the “copy tab” 401.

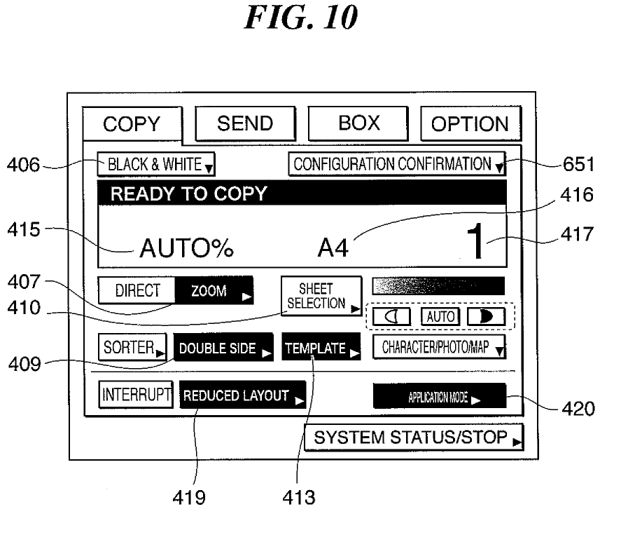

On the restored screen under the “copy tab” 401, the keys used for the configuration are displayed in reverse video, as shown in FIG. 10, for discrimination between the used keys and the others. Thus, the configured settings are reflected on the screen under the “copy tab” 401, such that “auto %” is displayed as magnification information 415, and “A4” as sheet size information 416. Further, a configuration confirmation key 651 is displayed for calling a “configuration confirmation” screen for confirming the configured settings to be reproduced based on job history by character display.

It is also possible to only confirm the configured settings without performing screen transition display operations. This confirmation method can be set on a “system configuration” screen called by the user mode key 310. On the “system configuration” screen, it is possible to configure several settings (including a time interval for reproduction of configuration screens) related to the reproduction of a series of configuration screens.

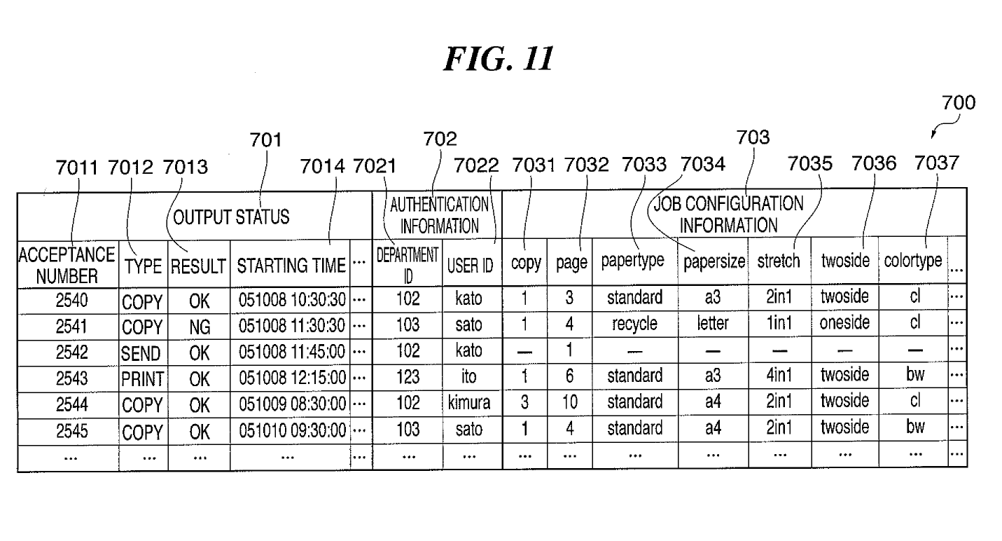

Next, job history information stored in the job history storage area 2061 of the storage section 206 of the control section 200 will be described with reference to FIG. 11. FIG. 11 is a view showing an example of a job history table stored in the job history storage area 2061 of the storage section 206.

The job history storage area 2061 stores the job history table 700 shown in FIG. 11. In the job history table 700, there are entered a predetermined number of history information items associated with respective jobs carried out by the MFP 100 for copying, printing, scanning, and sending, starting from the latest one. The job history table 700 is comprised of items of output status 701, authentication information 702, and job configuration information 703, in each of which is entered corresponding information.

The output status 701 includes an acceptance number 7011 for uniquely identifying a job history information item, and a type 7012 for discriminating between job types, such as copying, printing, scanning, and sending. Further, the output status 701 includes a result 7013 indicative of a processing result, such as success, failure, or cancellation, and a starting time 7014 indicative of the starting time of a job. Job history information items extracted as candidates for selection from the job history table 700 by the job history selection section 2051 belong to the same job type as indicated by a selected tab (e.g. the “copy tab” 401), and have the result of success. This extraction is performed based on information of the type 7012 and the result 7013.

The authentication information 702 is used when the MFP 100 is configured to authenticate a user before the user starts using the MFP 100. The authentication information 702 is comprised of a department ID 7021 for identifying a department to which a user who executed a job associated with a job history information item belongs, and a user ID 7022 for identifying the user. In the case where the MFP 100 is configured to perform user authentication, job history information items extracted as candidates for selection from the job history table 700 by the job history selection section 2051 are those of a department ID with which is associated the user ID of an authenticated user. Alternatively, only job history information of a user ID corresponding to the user may be extracted. When the user is not authenticated as an authorized user, extraction may be canceled, or only job history information with no authentication information concerning a specific department ID or a specific user ID may be extracted.

The job configuration information 703 contains a plurality of information items indicative of respective parameters set for job execution. The parameters set by the user may include not only parameters set on the touch panel section 2041, but also parameters set by a remote computer via a printer driver for printing or a Web browser. The parameters contained in the job configuration information 703 include a copy 7031 indicative of a copy count, a page 7032 indicative of a page count, a papertype 7033 indicative of a media type, and a papersize 7034 indicative of a sheet size. Further, the job configuration information 703 contains, as parameters, a stretch 7035 indicative of a reduced layout, a twoside 7036 indicative of double-sided output or single-sided output, and a colortype 7037 indicative of a color.

Whenever the number of job history information items stored in the job history table 700 exceeds a predetermined upper limit value defining the maximum number of storable information items, or whenever a storage period over which stored job history information items should be stored elapses, information items are sequentially deleted from the oldest one.

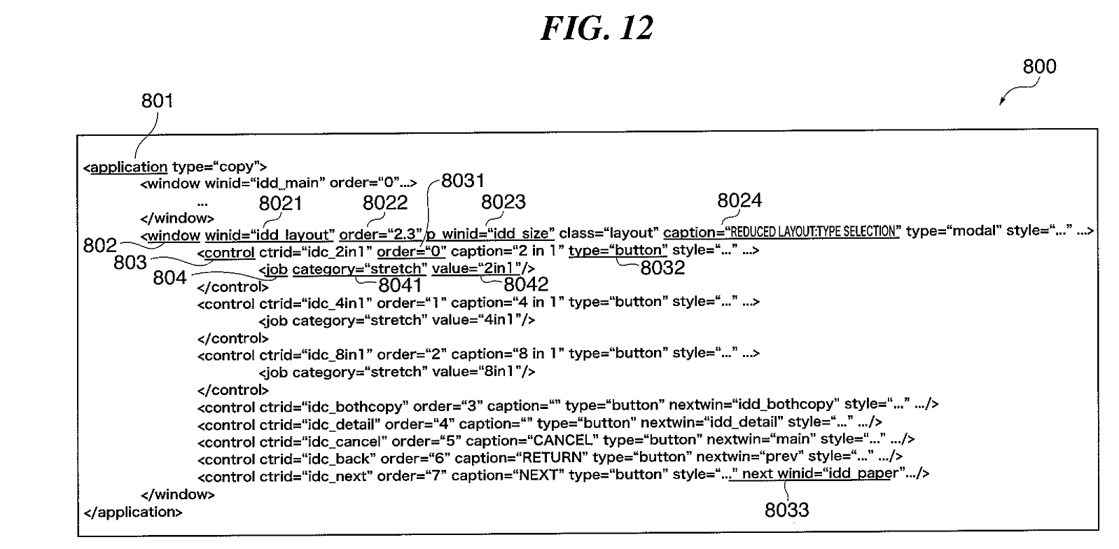

Next, screen layout information stored in the screen layout storage area 2062 of the storage section 206 of the control section 200 will be described with reference to FIG. 12. FIG. 12 is a view showing an example of screen layout information stored in the screen layout storage area 2062.

The screen layout storage area 2062 stores a screen layout table 800 shown in FIG. 12. In the screen layout table 800, there are described screen layout information defining a layout of each screen to be displayed on the touch panel section 2041, a sequence of screens to be displayed, the arrangement of components on each screen, and so forth. In the screen layout table 800 of the illustrated example, the layout of the “type selection” screen in FIG. 8 is described in the XML (Extensible Markup Language) format. Although the illustrated example shows the screen layout table 800 described in the XML format, a screen layout table may be described in the text format or in the relational database format.

In the screen layout table 800, an “application” tag 801 indicates an application type, such as the copy tab 401, the send tab 402, or the box tab 403 in FIG. 4. In the illustrated example, the layout of the screen under the copy tab 401 is expressed. A “window” tag 802 indicates that the following description defines a screen, and a “winid” attribute 8021 uniquely identifies the screen. In the present example, the “type selection” screen 630 in FIG. 8 is indicated by an identifier “idd_layout”.

Further, an “order” attribute 8022 indicates the position of the associated screen in a sequence of screens required to be called starting from the main screen, and when the value of the “order” attribute 8022 is equal to “0”, the screen (FIG. 6) under the copy tab 401 is displayed. The numerical value of the “order” attribute 8022 is utilized in analyzing the sequence of transitions of configuration screens by the job configuration reproduction order-analyzing section 2052 which refers to the job configuration information 703 of job history information items extracted from the job history storage area 2061 and the screen layout table 800. Specifically, the sequence of transitions of configuration screens is analyzed based on the numerical values of the “order” attribute 8022 of the screens following a rule that screen transition is performed in ascending order from a screen corresponding to the minimum value of the “order” attribute 8022.

The “winid” of a parent screen as a caller from which is called the currently displayed screen is indicated by a “p_wind” attribute 8023 so as to specify which screen was used to call the currently displayed screen and which screen the currently displayed screen should return to. A “caption” attribute 8024 indicates the name of a screen. For example, a title displayed on the “type selection” screen 630 in FIG. 8 is quoted from the “caption” attribute 8024.

A “control” tag 803 indicates components on a screen. An “order” attribute 8031 indicates a position in a sequence of components on the same screen. The numerical value of the “order” attribute 8031 is utilized in analyzing components and a sequence of operations of the components by the job configuration reproduction order-analyzing section 2052 which refers to the job configuration information 703 of job history information items extracted from the job history storage area 2061 and the screen layout table 800. Specifically, the sequence of operations of the components is analyzed based on the numerical values of the “order” attribute 8031, following a rule that components are operated in ascending order of their value of the “order” attribute 8031, starting from a component corresponding to the minimum value.

A “type” attribute 8032 indicates a component type, and distinguishes between a button, a pull-down menu, a list, and so forth. Further, a “next-wind” attribute 8033 indicates the “winid” attribute of a transition destination screen as a next screen in screen transition caused by operating the associated component (e.g. a button).

A “job” tag 804 indicates parameters of job configuration information set by operating the associated component. A “category” attribute 8041 indicates a media type, a sheet size, a reduced layout, double-sided/single-sided output, a color, and so forth. In the present example, the “category” attribute 8041 is set to “stretch” (category=“stretch”). The “category” attribute 8041 setting is associated with a “stretch” 7035 (reduced layout) of the job configuration information 703 in the job history table 700 shown in FIG. 11.

A “value” attribute 8042 indicates a specific value of the “category” attribute 8041. In the present example, the “value” attribute 8042 is set to “2 in 1” (value=“2 in 1”). The “value” attribute 8042 is associated with the specific value (2 in 1 associated with acceptance number 2545) of the “stretch” 7035 (reduced layout) of the job configuration information 703 in the job history table 700 shown in FIG. 11.

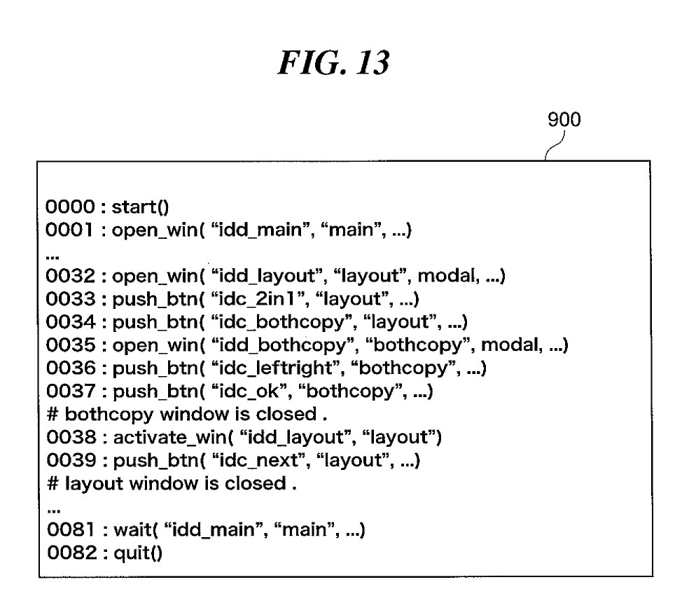

The job configuration reproduction order-analyzing section 2052 retrieves the value of the “category” attribute 8041 of the “job” tag 804 and that of the “value” attribute 8042 of the same so as to determine a sequence of screen configurations/transitions. By this retrieval, the “control” tag 803 and the “window” tag 802, which the “job” tag 804 belongs to, are obtained, whereby which component on which screen should be operated is determined. Then, a sequence of screens to be displayed and a sequence of components to be operated on each screen are determined based on the values of the “order” attribute 8022 of the “window” tag 802 and those of the “order” attribute 8031 of the “control” tag 803. Then, a screen configuration/transition macro described in a format shown in FIG. 13 is generated so as to express the determined scenario. This screen configuration/transition macro is a script defining a sequence of causing a series of configuration screens related to job configuration and transitions thereof, components, such as buttons, on each of the configuration screens, and operations of the respective component, to be displayed in an animation-like manner on the touch panel section 2041. The generated screen configuration/transition macro is passed to the configuration reproduction section 2053. Then, the procedure of steps for configuring the selected job is reproduced by the configuration reproduction section 2053, based on the screen configuration/transition macro, and is displayed on the touch panel section 2041.

Next, the screen configuration/ transition macro stored in the macro information storage area 2063 of the storage section 206 will be described with reference to FIG. 13. FIG. 13 is a view showing an example of the screen configuration/transition macro 900 stored in the macro information storage area 2063 of the storage section 206. The following description is given of the example of the screen configuration/transition macro 900 assuming that there are extracted some of operations performed on the “type selection” screen 630.

Although, as shown in FIG. 13, the screen configuration/transition macro 900 is written in a script format executable by the configuration reproduction section 2053, any other description format can be used in place of the script format insofar as it can operate as specified. In the present embodiment, a screen configuration/transition macro generated by the job configuration reproduction order-analyzing section 2052 is described in the same format as that of the screen configuration/transition macro 900 stored in the macro information storage area 2063.

In the screen configuration/transition macro 900, an “open_win” command indicates an instruction for displaying a screen, and its argument designates a screen ID (“idd_layout”: the “type selection” screen 630), a class (“layout”), a mode (“modal”), and so forth. Further, a “push_btn” command indicates an instruction for button depression, and its arguments designate a component ID (“idc_{—}2 in 1”: 2-in-1 button), a screen class (“layout”), and so forth. In addition to these, there are provided commands expressing operations of screens and components. For example, an “activate win” command indicates screen activation, a “wait” command waiting for an input from a user, a “start” command starting of the script, and a “quit” command termination of the script.

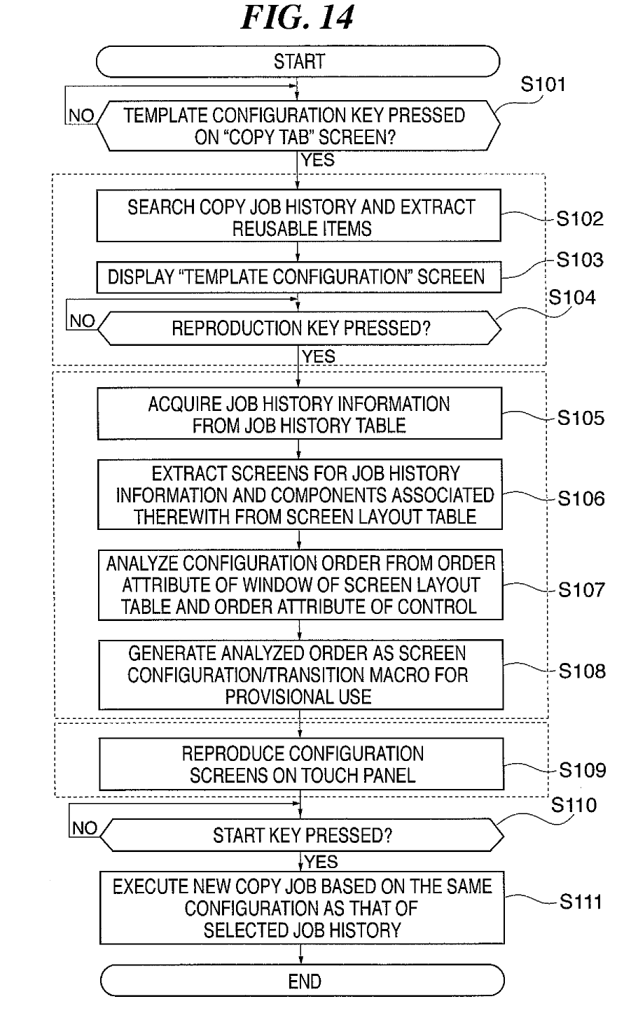

Next, a process for reproducing a series of configuration screens corresponding to a job history information item selected by the user, in the order of transition of the screens, on the touch panel section 2041, will be described with reference to FIG. 14. FIG. 14 is a flowchart of the process. The process shown in the flowchart in FIG. 14 is executed by the CPU 201 of the control section 200, and the process includes processing carried out by the job history selection section 2051, the job configuration reproduction order-analyzing section 2052, and the configuration reproduction section 2053. In the following, a description will be given of reproduction of a series of configuration screens corresponding to copy job history information.

As shown in FIG. 14, the CPU 201 monitors depression of the template configuration key 413 by the user on the screen (FIG. 4) under the “copy tab” 401 (step S101). When the template configuration key 413 is pressed by the user, the CPU 201 activates the job history selection section 2051. The job history selection section 2051 searches the job history storage area 2061 of the storage section 206 to extract a list of copy job history information items as candidates for selection for configuration reproduction, i.e. reusable copy job history information items. The copy job history information items selected here as candidates for selection are those whose results 7013 are OK (i.e. success). Further, if user authentication has been carried out for login, a list of copy job history information items with a department ID 7021 associated with the user ID of the user having logged in is extracted (step S102). Then, the job history selection section 2051 displays the “template configuration” screen 500, an example of which is shown in FIG. 5, on the touch panel section 2041 via the operation control section 203 (step S103). The “template configuration” screen 500 contains the job history/selection list 501 and the registered macro/selection list 502.

Then, the job history selection section 2051 waits for the user to select one job history information item from the job history/selection list 501 and press the reproduction key 505 (step S104). When the reproduction key 505 is pressed, the CPU 201 activates the job configuration reproduction order-analyzing section 2052. The job configuration reproduction order-analyzing section 2052 searches the job history table 700 stored in the job history storage area 2061, using an acceptance number associated with the selected job history information item as a key. Then, information items (sheet size, double-sided/single-sided output, color, etc.) contained in job configuration information 703 associated with the selected job history information item are obtained (step S105).

Then, the job configuration reproduction order-analyzing section 2052 searches the screen layout table 800 stored in the screen layout storage area 2062. By this search, configuration screens for setting the information items of the job configuration information 703 obtained in the step S105, and components to be operated on each of the configuration screens are extracted (step S106). In the illustrated example, configuration screens and components whose attributes 8041 and 8042 of the job tag 804 in the screen layout table 800 matching the obtained information items (e.g. 7034, 7035, 7037) of the job configuration information 703 are extracted. Then, based on retrieved screens (window tag 802) and components (control tag 803), to which the job tag 804 belongs, screens and components for setting the values of the respective information items of the job history information are extracted.

Next, based on the numerical values of the “order” attribute 8022 of the “window” tag 802 and those of the “order” attribute 8031 of the “control” tag 803, the job configuration reproduction order-analyzing section 2052 arranges the extracted screens and components in ascending order. This determines the sequence of configuration screens corresponding to the job history information and the sequence of transitions of the screens, and the components to be operated on each of the configuration screens and the sequence of operation of the components (step S107). Then, a screen configuration/transition macro (e.g. the macro 900 shown in FIG. 13) is generated which defines, for provisional use, and the sequence of configuration screens and the sequence of transitions of the screens as well as the components to be operated on each of the configuration screens and the sequence of operation of the components (step S108).

Next, the CPU 201 activates the configuration reproduction section 2053. The configuration reproduction section 2053 receives the screen configuration/transition macro generated by the job configuration reproduction order-analyzing section 2052. The configuration reproduction section 2053 reproduces the sequence of configuration screens based on the received screen configuration/transition macro, and displays the screens on the touch panel section 2041 (step S109). In this processing, as described hereinabove, the configuration screens shown in FIGS. 6 to 10 are sequentially reproduced in the transition order, in an animation-like manner, at predetermined time intervals (e.g. 0.5 sec.) which allow the user to view each screen.

In this respect, the present apparatus can be configured such that after completion of the reproduction of the configuration screens or during the reproduction, an operation carried out by the user on the touch panel section 2041 for changing a configuration value may be accepted to change the value. In this case, assuming that an operation is carried out on the currently displayed screen, upon reception of this operation, screen transition from the currently displayed screen to the following screen is temporarily stopped, and then after the configuration value being changed, reproduction of the following screen et seq. is resumed.

Further, when some exception handling occurs during the reproduction of the configuration screens, it is possible to display an error message or the like during the reproduction performed based on the screen configuration/transition macro for provisional use, and resume the reproduction after completion of the exception handling. Alternatively, the reproduction may be suspended.

Viewing the reproduced sequence of configuration screens, the user confirms the same configuration information as that associated with the selected job history information item. Then, to start the copy job based on the configuration information confirmed by the user, as a new copy job, the user presses the start key 303 of the key input section 2042. After completion of reproduction of the configuration screens, the CPU 201 is monitoring the depression of the start key 303 (step S110). Therefore, when the start key 303 is pressed, the CPU 201 executes the new copy job based on the same configuration information as that associated with the selected job history information item (step S111).

Next, a description will be given of the case where a job history information item selected from the job history/selection list 501 is registered as a macro, using the macro registration key 504.

In this case, the contents of the selected job history information item and those of the screen layout storage area 2062 are analyzed by the job configuration reproduction order-analyzing section 2052 to thereby determine a series of configuration screens for reproducing configuration information associated with the selected job history information item and a sequence of transitions of the screens. Then, a screen configuration/transition macro is generated which defines the determined series of configuration screens and the determined sequence of transitions of the screens. When this screen configuration/transition macro is generated, the name of the screen configuration/transition macro, and so forth are entered on a “macro registration” screen, not shown, for registering the screen confiquration/transition macro. Then, a macro number is given to the screen configuration/transition macro, whereafter the macro is stored in the macro information storage area 2063. Information on the registered screen configuration/transition macro is additionally displayed in the registered macro/selection list 502. In the job history table 700, as described hereinbefore, whenever the number of job history information items stored therein exceeds a predetermined upper limit value defining the maximum number of storable information items, or whenever a storage period over which stored job history information items are allowed to be stored elapses, information items are sequentially deleted from the oldest one. Therefore, by calling a frequently used configuration of a function of the image forming apparatus from the job history information and storing the same as macro information, it is possible to prevent the configuration of the function from being deleted and made unusable.

Next, a description will be given of the case where configuration information is reproduced based on one macro information item selected from a list of screen configuration/transition macro items displayed in the registered macro/selection list 502.

In this case, first, one macro information item is selected by the user from the list of screen configuration/transition macro items displayed in the registered macro/selection list 502. Then, when the reproduction key 505 is pressed, the selected macro information item is passed to the configuration reproduction section 2053. The configuration reproduction section 2053 reproduces a sequence of configuration screens, based on the received macro information item, in the order of transition of the screens, and displays a sequence of configuration screens on the touch panel section 2041.

Although in the present embodiment, a sequence of configuration screens for reproducing the same configuration information as that associated with a job history information item are reproduced based on the job history information item in an MFP having a plurality of functions, this is also applicable to a single-function image forming apparatus. For example, in a copy job executed by an apparatus having the copying function alone, it is possible to reproduce a sequence of configuration screens based on copy job history information.

As described above, according to the present embodiment, even a user inexperienced in configuration operation can easily carry out configuration operations concerning a job.

It is to be understood that the object of the present invention may also be accomplished by supplying a system or an apparatus with a storage medium in which a program code of software, which realizes the functions of the above described embodiment, is stored, and causing a computer (or CPU or MPU) of the system or apparatus to read out and execute the program code stored in the storage medium.

In this case, the program code itself read from the storage medium realizes the functions of the above described embodiment, and therefore the program code and the storage medium in which the program code is stored constitute the present invention.

Examples of the storage medium for supplying the program code include a floppy (registered trademark) disk, a hard disk, a magnetic-optical disk, an MO, an optical disk, such as a CD-ROM, a CD-R, a CD-RW, a DVD-ROM, or a DVD-R, a magnetic tape, a nonvolatile memory card, and a ROM. Alternatively, the program may be downloaded via a network.

Further, it is to be understood that the functions of the above described embodiment may be accomplished not only by executing the program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to exemplary embodiments, it is to be understood that the invention is not limited to the disclosed the embodiments. The scope of the following claims is to be accorded the broadest interpretation so as to encompass all such modifications and equivalent structures and functions.

This application claims the benefit of Japanese Patent Application No. 2006-22773, filed Jan. 31, 2006 which is hereby incorporated by reference herein in its entirety.

What is claimed is:

1. An image forming apparatus comprising:
a display unit adapted to display a configuration screen for use in carrying out configuration operations concerning a job;
a storage unit adapted to store history records, on an executed job-by-executed job basis, each of the history records containing configuration information indicating a configuration concerning each job;
a selection unit adapted to select one of the history records stored in said storage unit; and
a display control unit adapted to cause said display unit to sequentially display a series of configuration screens for use in carrying out configuration operations indicated by configuration information contained in the one of the history records selected by said selection unit.

2. An image forming apparatus as claimed in claim 1, further comprising a screen information storage unit adapted to store configuration screen information items associated with respective configuration information items, and
a generation unit adapted to identify configuration screen information corresponding to the configuration information contained in the history record selected by said selection unit, from the configuration screen information items stored by said screen information storage unit, and determine a sequence of display of the series of configuration screens, based on display order information contained in the identified configuration screen information, to thereby generate display information, and
wherein said display control unit causes said display unit to sequentially display the series of configuration screens based on the display information generated by said generation unit.

3. An image forming apparatus as claimed in claim 1, further comprising a configuration changing unit adapted to modify the configuration information by accepting a modification made to the configuration information on any of the configuration screens displayed on said display unit by said display control unit.

4. An image forming apparatus as claimed in claim 1, wherein said selection unit extracts a list of history records of normally completed jobs as candidates for selection.

5. An image forming apparatus as claimed in claim 4, further comprising a job type selection unit adapted to select a type of a job to be executed, and
wherein said selection unit extracts history records of jobs of the same type as the job type selected by said job type selection unit, as the candidates for selection.

6. A method of controlling an image forming apparatus including a display unit adapted to display a configuration screen for use in carrying out configuration operations concerning a job, and a storage unit adapted to store history records, on an executed job-by-executed job basis, each of the history records containing configuration information indicating a configuration concerning each job, comprising:
a job history selection step of selecting one of the history records stored in the storage unit; and
a display control step of causing the display unit to sequentially display a series of configuration screens for use in carrying out configuration operations indicated by configuration information contained in the one of the history records selected in said job history selection step.

7. A program executable by an image forming apparatus including a display unit adapted to display a configuration screen for use in carrying out configuration operations concerning a job, and a storage unit adapted to store history records, on an executed job-by-executed job basis, each of the history records containing configuration information indicating a configuration concerning each job, comprising:
a job history selection module for selecting one of the history records stored in the storage unit; and
a display control module for causing the display unit to sequentially display a series of configuration screens for use in carrying out configuration operations indicated by configuration information contained in the one of the history records selected by said job history selection module.
